(19) United States
(12) Patent Application Publication
(10) Pub. No.: US 2014/0256389 A1
(43) Pub. Date: Sep. 11, 2014

(54) MOBILE GAME APPLICATION

(71) Applicants: Ian Wentling, Wichita, KS (US); Connie Jo Dutton, Wichita, KS (US)

(72) Inventors: Ian Wentling, Wichita, KS (US); Connie Jo Dutton, Wichita, KS (US)

(21) Appl. No.: 14/189,791

(22) Filed: Feb. 25, 2014

Related U.S. Application Data
(60) Provisional application No. 61/773,719, filed on Mar. 6, 2013.

(51) Int. Cl. A63F 13/00

(52) U.S. Cl. CPC A63F 13/005; A63F 2300/204; A63F 2300/572; A63F 2300/6018; A63F 2300/8094
USPC 463/2

(57) ABSTRACT

A game application for use on a portable electronic device comprises an asset creation interface and a projectile launching game screen. The asset creation interface includes an image source selection interface, an asset bank, an image editor, an object editor, and a scene editor. A user may import an image or take a picture with the camera of the mobile device, edit the image in the image editor, create projectiles, targets, launchers, and backgrounds in the object editor, and create scenes including various projectiles, targets, launchers, and backgrounds in the scene editor. The user may select the assets (projectiles, targets, launchers, backgrounds, and scenes) to be used in a projectile launching game and share assets with other users via social media outlets over a wireless network.

### CROSS REFERENCE TO RELATED APPLICATION

This non-provisional patent application claims priority to U.S. Provisional Patent Application No. 61/773,719 filed on Mar. 6, 2013, the entire contents of which is herein incorporated by reference in its entirety.

### BACKGROUND

Mobile game applications have become increasingly popular because of the rise in use of smartphones and other portable electronic devices. Many games like Angry Birds and Crush the Castle allow players to launch virtual projectiles towards virtual targets in an attempt to knock the targets down and/or destroy them. The projectiles and the targets typically follow a theme such as cartoon animals or a medieval castle siege. One of the drawbacks of these games is that their themes and artwork lose their appeal after repeated playing. The gameplay of these games is also limited to the activity of launching the projectiles at the targets.

### SUMMARY

The present invention solves the above-described problems and other shortcomings of existing mobile game applications by providing a mobile game application that includes an asset creation interface and a projectile launching game which allow players to create game assets and to play the projectile launching game with their created game assets.

The asset creation interface allows a player to import or create images and to edit and animate the images. The player may then create virtual objects such as projectiles and targets by assigning an image and physical properties such as weight, collision boundaries, collision elasticity, and damage threshold to the objects. The player may also create scenes comprising a set of launchers, projectiles, targets, and backgrounds.

The projectile launching game allows the player to select a scene or to individually select a launcher, a set of projectiles, a set of targets, and a background and then to launch the projectiles at the targets. If a projectile hits a target, the projectile and the target respond based on their physical properties. For example, the player may select a banana as a projectile, and the banana will bounce off of a window and will not cause sufficient damage to break the window. The projectile and target will also trigger animations and sounds according to the result of the collision. For example, the player may select a brick as a projectile, and the brick will shatter the window and a crashing sound will play. The player may be awarded points, achievements, or other incentives based on targets destroyed or objectives completed.

The player may also collaborate with and share his or her game assets with other players via the internet, email, SMS message, and social media outlets such as Facebook and Twitter. The player may also buy and sell game assets in a virtual marketplace for real or virtual money.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a screen display of a main menu screen of an embodiment of the mobile game application of the present invention shown on a portable electronic device;

FIG. 2 is a screen display of an asset creation interface of the mobile game application of FIG. 1 shown on a portable electronic device;

FIG. 3 is a screen display of an image source selection interface of the asset creation interface of FIG. 2 shown on a portable electronic device;

FIG. 4 is a screen display of an asset bank screen of the asset creation interface of FIG. 2 shown on a portable electronic device;

FIG. 5 is a screen display of an image editor of the asset creation interface of FIG. 2 shown on a portable electronic device;

FIG. 6 is a screen display of an object editor of the asset creation interface of FIG. 2 shown on a portable electronic device;

FIG. 7 is a screen display of a scene editor of the asset creation interface of FIG. 2 shown on a portable electronic device; and

FIG. 8 is a screen display of a projectile launching game screen of the mobile game application of FIG. 1 shown on a portable electronic device.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Turning now to the drawing figures, an embodiment of the present invention is a mobile game application for playing on a portable electronic device 10. The mobile game application broadly includes a main menu screen 12, an asset creation interface 14, and a projectile launching game screen 16.

The mobile game application comprises computer code and/or executable instructions for implementing the functions described below and can be embodied in any non-transitory computer readable medium for use by or in connection with an instruction execution system, apparatus, or device such as the portable electronic device 10. The mobile game application preferably comprises ordered listings of executable instructions for implementing logical functions in the portable electronic device 10. In the context of this document, a “computer-readable medium” can be any means that can contain, store, communicate, propagate or transport the program for use by or in connection with the instruction execution system, apparatus, or device. The non-transitory computer-readable medium can be, for example, but is not limited to, an electronic, magnetic, optical, electromagnetic, infrared, or semi-conductor system, apparatus, device, or propagation medium. More specific, although not inclusive, examples of the computer-readable medium would include the following: a portable computer diskette, a random access memory (RAM), a read-only memory (ROM), an erasable, programmable, read-only memory (EPROM or Flash memory), an optical fiber, and a portable compact disk read-only memory (CDROM).

The portable electronic device 10 may be a mobile smartphone, a portable music player, a portable gaming device, a tablet, a laptop computer, a hybrid tablet/laptop, a television, a gaming console, or any other computing device. The portable electronic device 10 includes a display screen and a means for navigating graphical user interfaces such as a touch-sensitive screen, a mouse, a keyboard, a video game controller, a motion-sensitive wand, a stylus, or a remote control. The display screen is configured to display the interfaces, screens, pages, windows, scenes, images, animations, videos, webpages, and other visual media and assets of the mobile game application. The portable electronic device 10 also includes an internal or removable memory or storage component and a wireless transmitting and receiving component for wirelessly connecting to other mobile devices and for wirelessly connecting to remote servers or other devices over an internet connection, a 3G, 4G, or 5G or future wireless telecommunications network, and a near field communication (NFC) connection.

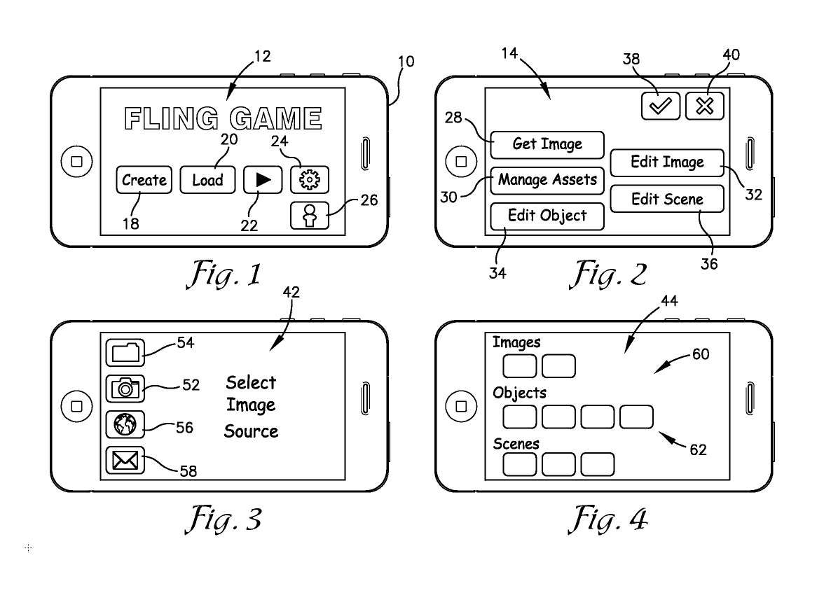

The main menu screen 12 is provided for greeting the player and for directing the player towards the asset creation interface 14, the projectile launching game screen 16, a settings and options screen, social media outlets, and other features, as shown in FIGS. 1, 2, and 8. The main menu screen 12 includes an application or game logo and virtual buttons, icons, or other user-selectable inputs such as a create button 18, a load button 20, a play button 22, a settings button 24, and a share button 26. The create button 18 initiates the asset creation interface 14 when selected, the load button 20 allows the player to load a saved game or saved game assets, the play button 22 includes a right facing triangle icon and launches the projectile launching game screen 16, the settings button 24 has a gear icon and initiates an options or settings menu, and the share button 26 has a logo of a social media outlet and initiates a social media application or website.

The asset creation interface 14 shown primarily in FIG. 2 is provided for allowing the player to create game assets for use in a projectile launching game and includes buttons, icons, or other user-selectable inputs such as an image retrieval button 28, an asset bank button 30, an edit image button 32, an edit object button 34, an edit scene button 36, an accept button 38, and a back button 40. The image retrieval button 28 initiates an image source selection interface 42 when selected, the asset bank button 30 initiates an asset bank screen 44, the edit image button 32 initiates an image editor 46, the edit object button 34 initiates an object editor 48, the edit scene button 36 initiates a scene editor 50, the accept button 38 saves the player's changes and initiates the projectile launching game screen 16, and the back button 40 returns the player to the main menu screen 12.

The image source selection interface 42 is provided for allowing the player to select an image source and includes buttons, icons, or other user-selectable inputs such as a camera button 52, a camera roll button 54, an internet button 56, and a message button 58, as shown in FIG. 3. The camera button 52 initiates a built-in camera on the portable electronic device 10 when selected, the camera roll button 54 initiates a virtual camera roll stored on the memory of the portable electronic device 10, the internet button 56 initiates an internet browser, and the message button 58 initiates an email inbox or an SMS message service.

The asset bank screen 44 is provided for allowing the player to manage imported, shared, edited, and saved images, objects, scenes, and other assets in a virtual asset bank. The asset bank screen 44 displays the game assets as thumbnails 60 or by name and may display a set of stock game assets 62 for helping the player learn how to edit images and objects and for helping the player learn how to play the projectile launching game, as shown in FIG. 4. The asset bank screen 44 groups the game assets into images, launchers, projectiles, targets, backgrounds, scenes, and other virtual objects and may be searchable by name, creator, date created, and physical attributes.

The image editor 46 is provided for manipulating an image 64 obtained from the image source and includes buttons, icons, or other user-selectable inputs such as a move button 66, a trace button 68, a zoom in button 70, a zoom out button 72, and a rotate button 74, as shown in FIG. 5. The image editor 46 may also include a color wheel, a color fill tool, a color pick tool, image compression and file conversion buttons, and an image name input box. The user-selectable inputs are provided for implementing image manipulation commands such as crop, trim, resize, stretch, zoom, trace, cut, paste, copy, translate, rotate, fragment, animate, discard, and save. The user-selectable inputs may be active or inactive based on the intended use of the image 64 (e.g., projectile or background).

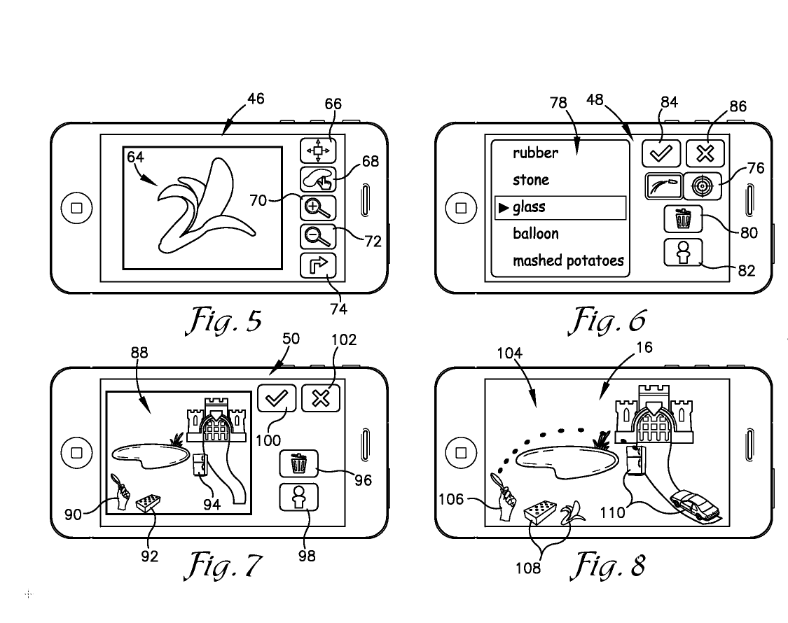

The object editor 48 is provided for allowing the player to create and edit virtual objects with physical attributes and an associated image and to select virtual objects to be used in the projectile launching game. The object editor 48 includes buttons, icons, or other user-selectable inputs such as an object type switch 76, an attribute menu 78, a discard button 80, a share button 82, an accept button 84, and a back button 86, as shown in FIG. 6. The object type switch 76 allows the player to change the object type between a launcher, a projectile, a target, a background, or another virtual object. Alternatively, the object will take the object type indicated by the chosen image. The attribute menu 78 allows the player to give the object physical properties such as weight, collision elasticity, and damage threshold. The attribute menu 78 may allow the player to give the object other attributes such as collision boundaries, animations, sounds, point values for collisions, damage inflicted, and additional collision effects such as solid, liquid, squishy, shatter, splatter, snap, and melt. A collision boundary (also sometimes referred to as a “hit box”) may be displayed as a distinguishable outline or as a filled-in shape, which may or may not coincide with the edges of the image. The discard button 80 allows the player to delete an object or to remove one of its properties. The share button 82 initiates a social media application or website for sharing game assets with other players. The accept button 84 saves the player's changes and initiates the projectile launching game screen 16, and the back button 86 returns the player to the asset creation interface 28.

The scene editor 50 is provided for allowing the player to combine game assets selected from the asset bank such as a background 88, a launcher 90, a projectile 92, and a target 94 into a playable level or puzzle (i.e., a scene). The scene editor 50 includes buttons, icons, or other user-selectable inputs such as a discard button 96, a share button 98, an accept button 100, and a back button 102, as shown in FIG. 7. The discard button 96 allows the player to delete a scene or to delete a game asset from the scene, the share button 98 initiates a social media application or website for sharing scenes with other users, the accept button 100 saves the player's changes and initiates the projectile launching game screen 16, and the back button 102 returns the player to the asset creation interface 28.

The projectile launching game screen 16 is provided to allow the player to play the projectile launching game (described below) and displays a background 104, a launcher 106, projectiles 108, and targets 110, and other game assets chosen from the asset bank for use in the projectile launching game, as shown in FIG. 8. The projectile launching game screen 16 may include invisible zones or locations for the game assets to be placed. For example, a two-dimensional target zone on the right side of the projectile launching game screen 16 is provided for allowing the player to position one or more targets 110 anywhere within its bounds. The launcher 106 and selectable projectiles 108 or projectiles in queue are positioned near the bottom left of the projectile launching game screen 16. Selectable targets 110 or targets in queue are positioned near the bottom right of the projectile launching game screen 16. The projectile launching game screen 16 may be preceded by additional setup screens or prompts that allow the player to choose a game mode such as sandbox, campaign, endless play, and multiplayer.

Gameplay of the above-described mobile game application will now be described. The mobile game application first loads the title or main menu screen 12 in which the player chooses whether to create or manage game assets using the asset creation interface 14, to play the projectile launching game via the projectile launching game screen 16, or to interact with other players via social media outlets.

The player may open the asset creation interface 14 (FIG. 2) from the main menu screen 12 (FIG. 1) to create and edit images, objects, and scenes. To create an image, the player first selects an image source from the image source selection interface 42 (FIG. 3). For example, the player may open the camera application on the portable electronic device 10 and take a digital picture using the mobile device's built-in camera or the player may retrieve an image from the image sources described above. The image editor 46 then displays the digital picture or other image 64 for the player to edit (FIG. 5). The player uses the image editor 46 to tailor the image 64 for use as a target, a projectile, or a launcher. For example, the player may crop or trim a picture of a banana by dragging his finger around the edges of the banana so that only the banana remains. The player may also name the image 64 using an input box. When the player is satisfied with the image 64, he may save the image 64 in the asset bank or it is saved automatically.

The player may then open the object editor 48 (FIG. 6) to create or to select an object from the asset bank for use in the projectile launching game. The player selects an image and an object type (launcher, projectile, target) to be assigned to the object and then chooses or changes the physical properties and attributes that are available for the chosen object type in the attribute menu 78. For example, the player may select the image of the banana, identify the banana as a projectile, and then give the banana a low damage threshold with a splatter collision animation and a squishy sound effect. The player may also name the object using an input box. When the player is satisfied with the object, he may save the object in the asset bank or it is saved automatically.

The player may then optionally open the scene editor 50 (FIG. 7) to create a scene. The player selects a background 88, a launcher 90, one or more projectiles 92, and one or more targets 94 to complete the scene. For example, the player may choose a castle lawn as the background, a spoon as the launcher, a brick and a banana as projectiles, and a refrigerator and a car as targets. When the player is satisfied with the scene, he may save the scene in the asset bank or it is saved automatically.

The player may access the projectile launching game screen 16 (FIG. 8) for playing the projectile launching game after creating game assets or by choosing to play directly from the main menu screen 12. Depending on the game mode, the projectile launching game screen 16 or a preceding setup screen may prompt the player to select objects created in the object editor 48 and/or scenes created in the scene editor 50 by opening the asset bank screen 44, the object editor 48, or the scene editor 50. In sandbox mode, the player selects objects or scenes and launches the projectiles at the targets without a specific goal or objective. In campaign mode, the player attempts to destroy targets to unlock subsequent levels. In endless play mode, the player's primary goal is to obtain a high score. In multiplayer mode, the player competes against other players over a wireless network to achieve any of the above objectives.

The player plays the projectile launching game by touching a projectile 108 or by moving a projectile 108 to the launcher 106. Alternatively the launcher 106 may be automatically loaded with a projectile 108. The player then slides his finger in a direction opposite the desired projectile trajectory to simulate a slingshot action. The player pulls his finger further from the launcher 106 to increase launching power. A projected trajectory based on the current position of the player's finger (for mobile devices with touch-sensitive screens) in relation to the launcher 106 dynamically updates for assisting the player in aiming at the target 110. Once the player is satisfied with the projected trajectory, he lifts his finger off of the screen and the player launching game then launches the projectile 108 along a trajectory based on the projected trajectory and any environmental effects such as wind as calculated by a physics engine of the projectile launching game. If the projectile 108 hits a target 110 or the target zone boundaries, the physics engine determines collision motion, collision effects and animations, and collision damage. Points, stars, achievements, unlocked levels, and other awards are given to the player for completing designated objectives. For example, one point may be awarded to the player for each unit of damage inflicted on the targets 110, and an achievement may be awarded for destroying ten targets in a row.

The mobile game application also allows the player to share game assets (objects, images, backgrounds, and scenes) with other players via social media outlets such as Facebook and Twitter and via wireless networks such as text messaging services, cellular networks, email, and the internet by selecting any one of the share buttons 26, 82, 98 displayed throughout the mobile game application. The player may assign a value or a price to each game asset for selling the game asset to other players on a virtual marketplace for virtual or real currency.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A game application stored on non-transitory computer readable memory of a portable electronic device, the game application comprising:
a code segment for implementing a projectile launching game screen for allowing a user to play a projectile launching game, the projectile launching game screen comprising:
a background; and
at least two virtual objects, one of the virtual objects being a target and one of the virtual objects being a projectile being configured to be launched at the target; and
a code segment for implementing a virtual object selection interface configured to allow the user to select at least one of the virtual objects to be used in the projectile launching game.

2. The game application of claim 1, wherein the virtual object selection interface is further configured to allow the user to select the background.

3. The game application of claim 1, further comprising a code segment for implementing a virtual object editor configured to allow a user to select properties of the virtual objects.

4. The game application of claim 3, wherein the virtual object editor is configured to allow the user to change each virtual object between being a target and a projectile.

5. The game application of claim 4, wherein the virtual object editor is further configured to allow the user to create and edit virtual launchers for launching the projectile in the projectile launching game.

6. The game application of claim 3, wherein the virtual object editor is further configured to allow the user to assign a collision effect to the virtual objects.

7. The game application of claim 6, wherein the collision effect is selected from the group consisting essentially of an animation, a collision image, a sound effect, and a physical property.

8. The game application of claim 3, wherein the game application is configured to allow the user to share virtual objects with other users over a wireless network.

9. The game application of claim 1, further comprising a code segment for implementing an image editor configured to allow a user to edit an image to be assigned to a virtual object, the object editing interface further being configured to allow the user to assign the image to one of the virtual objects.

10. The game application of claim 9, wherein the image editor is configured to allow the user to crop, trim, scale, and rotate the image.

11. The game application of claim 9, further comprising a code segment for implementing an image source selection interface configured to allow the user to choose an image source from a group of image sources for retrieving or creating an image for being edited in the image editor.

12. The game application of claim 11, wherein the group of image sources includes a camera, a virtual camera roll, a message inbox, and an asset bank of the game application.

13. The game application of claim 1, further comprising a code segment for implementing a scene editor configured to allow the user to create or edit a scene comprising a background, at least one target, and at least one projectile, the scene being configured to be loaded in the projectile launching game.

14. The game application of claim 13, wherein the game application further comprises a code segment for allowing the user to share scenes with other users over a wireless network.

15. The game application of claim 1, further comprising an asset bank code segment for storing backgrounds, projectiles, and targets for selection in the virtual object selection interface.

16. The game application of claim 15, further comprising a code segment for implementing an asset bank screen configured to display the backgrounds, the projectiles, and the targets separately.

17. A game application stored on non-transitory computer readable memory of a portable electronic device, the game application comprising:
a code segment for implementing a projectile launching game screen for allowing a user to play a projectile launching game, the projectile launching game screen comprising:
a background; and
at least two virtual objects, one of the virtual objects being a target and one of the virtual objects being a projectile being configured to be launched at the target;
a code segment for implementing an image source selection interface configured to allow the user to choose an image source from a group of image sources for retrieving or creating an image;
a code segment for implementing an image editor configured to allow the user to edit the image;
a code segment for implementing a virtual object editor configured to allow the user to create and edit the virtual objects and to assign an image edited in the image editor to the virtual objects edited in the virtual object editor;
a code segment for implementing a virtual object selection interface configured to allow a user to select at least one of the virtual objects to be used in the projectile launching game;

18. The game application of claim 17, wherein the projectile and the target are each assigned a damage value, and the projectile and the target each are virtually destroyed if they sustain damage greater than their respective damage value when the projectile is launched at the target and the projectile hits the target.

19. The game application of claim 17, wherein the game application includes stock virtual objects for helping the user become familiar with the game application.

20. A game application stored on non-transitory computer readable memory of a portable electronic device, the game application comprising:
a code segment for implementing a projectile launching game screen for allowing a user to play a projectile launching game, the projectile launching game screen comprising:
a background; and
at least two virtual objects, one of the virtual objects being a target and one of the virtual objects being a projectile being configured to be launched at the target;
a code segment for implementing an image source selection interface configured to allow the user to choose an image source from a group of image sources for retrieving or creating an image;
a code segment for implementing an image editor configured to allow the user to edit the image;
a code segment for implementing a virtual object editor configured to allow the user to create or edit the virtual objects, to assign an image edited in the image editor to the virtual objects edited in the virtual object editor, and to change the virtual objects between being a target, a projectile, and a launcher;
a code segment for implementing a virtual object selection interface configured to allow the user to select at least one of the virtual objects to be used in the projectile launching game;
a code segment for implementing a scene editor configured to allow the user to create a scene comprising at least one target, at least one projectile, at least one launcher, and at least one background; and
a code segment for allowing the user to share the images edited in the image editor, objects edited in the object editor, and scenes edited in the scene editor with other players over a wireless network.
